(19) United States
(12) Patent Application Publication
(10) Pub. No.: US 2005/0118393 A1
(43) Pub. Date: Jun. 2, 2005

(54) Sheet having microsized architecture

(76) Inventors: Craig S. Corcoran, Rockford, IL (US); William J. Jaecklein, Mentor, OH (US); Robert M. Pricone, Libertyville, IL (US); W. Scott Theilman, Palatine, IL (US); Cindy Chia-Wen Chiu, San Dimas, CA (US); David Hsein-Pin Chen, Buena Park, CA (US)

Correspondence Address: Cynthia S. Murphy;Renner, Otto, Boisselle & Sklar, LLP, Nineteenth Floor, 1621 Euclid Avenue, Cleveland, OH, 44115, US

(21) Appl. No.: 10/974,365

(22) Filed: Oct. 27, 2004

Related U.S. Application Data
(62) Division of application No. 10/346,242, filed on Jan. 17, 2003.
(60) Provisional application No. 60/349,596, filed on Jan. 18, 2002.

(51) Int. Cl. B32B 3/10

(52) U.S. Cl. 428/131

(57) ABSTRACT

A sheet (20) for use in microfluidic, microelectronic, micromechanical, and/or microoptical applications requiring through-flow, through-conductivity, through-transmission, and/or other through patterns. The sheet (20) includes micro-sized architecture including at least one via (22) extending through the thickness of the layer of thermoplastic material. The via-defining walls in the thermoplastic layer are formed by the thermoplastic material flowing around a projection and then solidifying around the projection.

### RELATED APPLICATION

This application claims priority under 35 U.S.C. §119(e) to U.S. Provisional Patent Application No. 60/349,596. The entire disclosure of this earlier application is hereby incorporated by reference.

### FIELD OF THE INVENTION

This invention relates generally to a sheet having architecture suitable for incorporation into microfluidic, microelectronic, micromechanical, and/or microoptical devices.

### BACKGROUND OF THE INVENTION

Microsized architecture refers to one or more microsized (e.g., having a dimension no greater than 1000 microns) structures arranged in a predetermined pattern on a substrate that can be, for example, a rigid or flexible sheet. Typical microsized architecture includes channels, wells, and/or recesses having depths less than the thickness of the unformed original substrate. These microsized architectures can include passages extending in the x-y directions of the substrate. Dimensions of these channels and wells range from 0.00020 to 0.008 inches (5-200 microns) depth; 0.00020 inches to 10 inches (5 microns to 25.4 cm) and the channels may have convoluted shapes.

Volumetric accuracy of the micropassages is very important in that in many applications a 90% or greater accuracy of the cross sectional area must be conserved through the length of channel, from channel to channel, and/or well to well. In addition to volumetric accuracy, the surface texture of the channel is extremely significant, especially, for example, in microfluidic applications. For example, the smoothness or roughness of the channel can affect friction, surface drag, diffusiveness and/or laminar vs. turbulent flow patterns. Furthermore, the level of residual stresses can be very relevant in that it is directly related to strand orientation, which can result in undesirable polarization and/or because relaxation of these stresses during subsequent processing or during the life cycle of the product result in dimensional instability.

### SUMMARY OF THE INVENTION

The present invention provides microsized architecture including vias which extend in the z-direction through the thickness of the substrate. In this manner, microfluidic, microelectronic, micromechanical, and/or microoptical applications requiring through-flow, through-conductivity, through-transmission, and/or other through patterns can be accommodated. Also, the present invention is believed to provide via-defining surfaces which have closer size-exactness, enhanced pattern precision, increased angle accuracy, and/or greater control of surface properties (e.g. texture) than via-defining surfaces formed by conventional methods, such as curing, ablation, stamping, roll embossing, photolithography, UV embossing and punching techniques.

More particularly, the present invention provides a sheet comprising a thermoplastic layer of a thermoplastic material and micro-sized architecture including at least one micro-via extending through the thickness of the layer of thermoplastic material. The sheet can have a thickness in the range of about fifteen to about three hundred microns, of about two hundred to about three hundred microns, of about forty to about one hundred microns, and/or about fifteen to about twenty-five microns. The via can have a minimal cross-sectional area with a dominating dimension that is less than the thickness of the thermoplastic material. Additionally or alternatively, the dominating dimension of the minimal cross-sectional area can be in a range of about five to twenty microns and/or about ten to about fifteen microns.

The via can have an axial dimension equal to the thickness of the thermoplastic layer, a first axial end corresponding to the maximum cross-sectional area of the via and a second axial end corresponding to the minimum cross-sectional area of the via. The first and second axial ends can have a similar geometry, can have different geometries, can have a polygonal geometry (regular or irregular), and/or can have a substantially circular (e.g., circle or oval) geometry. The via-defining walls of the sheet connecting the first and second axial ends can have a constant slope, can have a continuous changing slope (e.g., an arch-shaped slope) or can have a discontinuous changing slope (e.g., stepped).

The microsized architecture can comprise a single via or a plurality of vias. The plurality of vias can be separated from each other by a distance in the range of about thirty to about seventy microns and/or about fifty microns. They can be positioned in an array-arrangement of rows and columns and the rows/columns can be either aligned or staggered. The microsized architecture can further comprise one or more recesses (e.g., well, channel, etc.) which do not extend through the thickness of thermoplastic layer.

The sheet can have flat upper and lower x-y surfaces in which the vias and, if applicable, other indentations (e.g., x-y channels, recesses, or wells which do not extend through the thickness of the sheet) are formed. Instead, the microsized architecture can include structures projecting outwardly from its upper and/or lower surfaces whereby these structures, in combination with the vias, provide the sheet with multi-level topography. The projecting structures can be of the same or different heights depending on the architectural design.

The sheet can comprise a single layer of thermoplastic material. Alternatively, the sheet can comprise multiple layers of the same or different thermoplastic materials. With particular reference to multi-layer sheets made of different materials, co-extruded films can be used to provide a gradient of surface properties along the z-axis of the via(s).

According to a method of the present invention, the sheet can be made with a tool having a projection that is sized, shaped, and arranged to correspond to each via. Accordingly, if the microsized architecture includes a plurality of vias, the tool will include a plurality of projections. Also, if the desired architecture includes other indentations (e.g., channels, recesses, wells, etc.) and/or outwardly projecting structures, the tool can include reverse features of these architectural items so that they can be made simultaneously with the via(s).

In this method, the thermoplastic layer is heated so that the thermoplastic material is sufficiently flowable so that, when the tool and the thermoplastic layer are appropriately positioned relative to each other, the projections extend through the sufficiently flowable thermoplastic layer. The thermoplastic layer is then cooled so that the thermoplastic material solidifies around the projection(s). The tool and the thermoplastic layer are thereafter stripped from each other (e.g., the tool is stripped from the thermoplastic layer or the thermoplastic layer is stripped from the tool).

A carrier layer can be superimposed on the thermoplastic layer to provide the adjacent side of the thermoplastic layer with a desired surface morphology (e.g., a flat and highly finished surface) and/or to support the layer during certain method steps. To this end, the plastic carrier layer, if thermoplastic, can have a glass transition temperature substantially greater than the glass transition temperature of the target thermoplastic layer. During the manufacture of the sheet, the projections can extend partially or completely through the carrier sheet whereby recesses, aligned with the vias in the thermoplastic material, will be formed in the carrier sheet.

These and other features of the invention are fully described and particularly pointed out in the claims. The following description and drawings set forth in detail certain illustrative embodiments of the invention which are indicative of but a few of the various ways in which the principles of the invention may be employed.

### DRAWINGS

FIG. 1 is a top view of a sheet according to the present invention, the sheet having microsized architecture including an array of vias extending through the thickness (i.e., the z-direction) of the sheet.

FIG. 2 is side cross-sectional view of the sheet.

FIG. 2A is a schematic view showing the geometry of one of the vias in the sheet shown in FIGS. 1 and 2.

FIGS. 2B-2M are schematic views showing other possible geometries of the via according to the present invention.

FIGS. 3A-3C are side cross-sectional views of multi-layer sheets.

FIGS. 4A-4C are side schematic views of sheets incorporating other non-via architectural features.

FIGS. 5A-5I are schematic views of steps of a method of making the resinous sheet according to the present invention.

FIGS. 6A-6C are schematic views of the sheet wherein the vias are made electrically conductive according to the present invention.

FIGS. 7A-7C are schematic views of a plurality of sheets stacked according to the present invention and tools for making such sheets.

FIGS. 8A-8C are schematic views of covered sheets according to the present invention.

FIGS. 9A-9C are schematic views of a via having a microstructure block contained therein and assembly steps for positioning the microstructure blocks in the vias.

### DETAILED DESCRIPTION

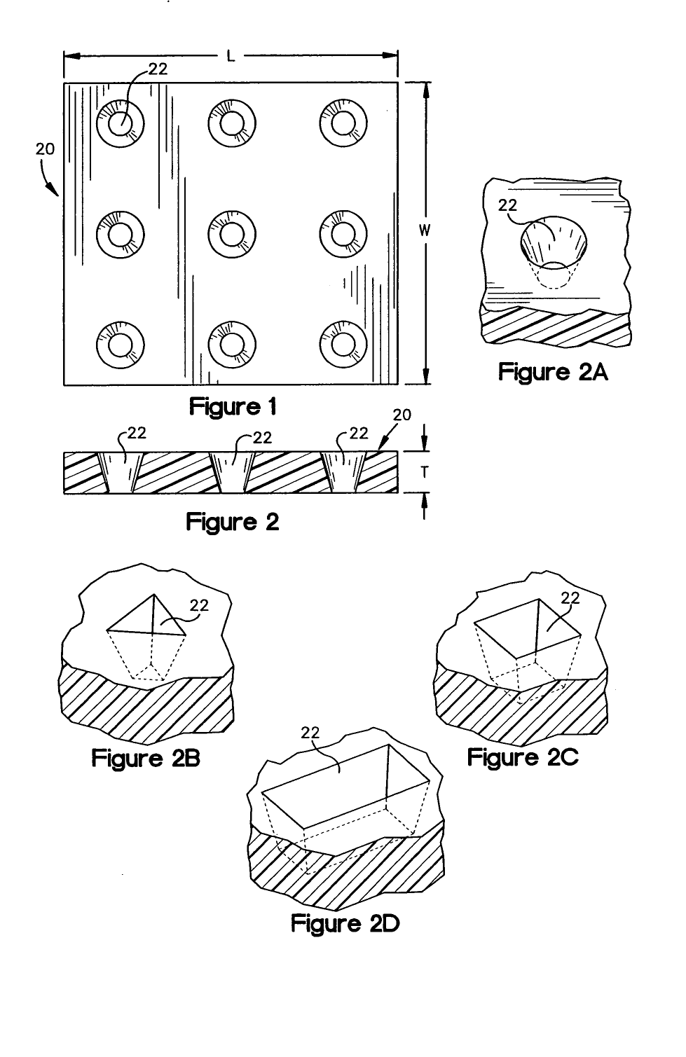

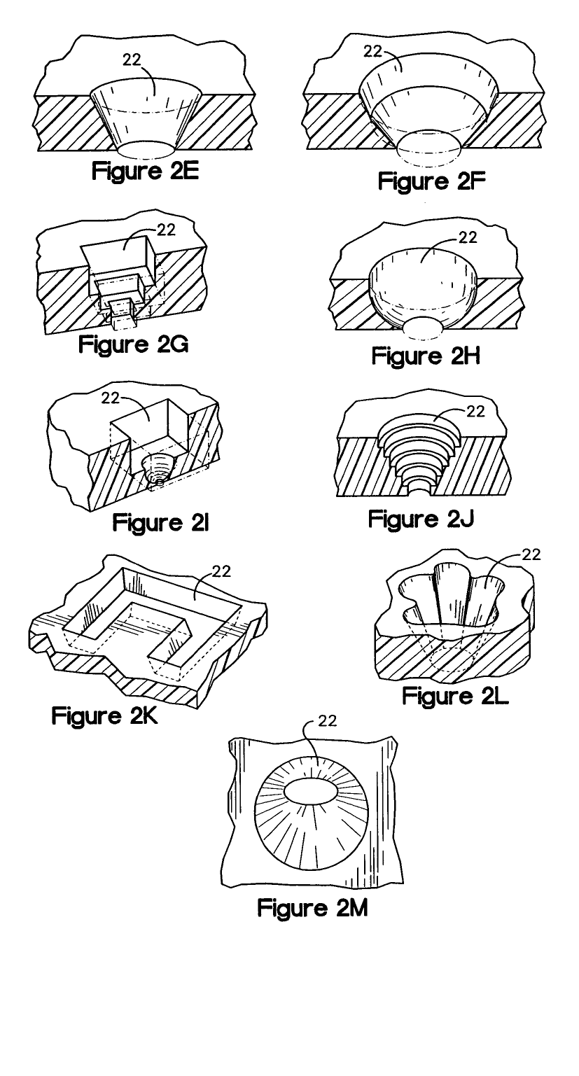

Referring now to the drawings in detail, and initially to FIGS. 1 and 2, a sheet 20 according to the present invention is shown. The sheet 20 includes microstructure architecture including an array of vias 22 extending completely through the sheet 20. In this manner, applications requiring through-flow, through-conductivity, or other through patterns can be accommodated by the sheet 20.

The sheet 20 can be a single layer of a thermoplastic material or a plurality of thermoplastic layers compatible with its intended application. For example, the thermoplastic material may comprise polyolefins, both linear and branched, polyamides, polystyrenes, polyurethanes, polysulfones, polyvinyl chloride, polycarbonates, and acrylic polymer and copolymer. If the sheet 20 is to be incorporated into a chemical, biochemical, or pharmaceutical assay, then a polymer/copolymer can be chosen that is chemically inert to the samples and reagents used in the assay or has other innate features that may enhance overall performance of the device, such as surface hydrophilicity/hydrophobicity. If the sheet 20 is to be incorporated into an instrument that relies on emissive or reflective characteristics for detection of an event of interest (e.g., fluorimetry, colormetry or spectroscopy), then a polymer/copolymer can be selected that does not interfere with the absorption or emission of the signals to or from the sample. If the product sheet 20 is to be incorporated into electrical circuitry, then the electrical/dielectric qualities of the polymer/copolymer can be considered.

The sheet 20 can have a generally planar geometry having, for example, a width W, a length L, and a thickness T. The width W can be constant across the sheet's length and can be of a dimension compatible with the equipment used to incorporate the sheet 20 into the desired final product. The length L can be a predetermined distance in the same general range as the width W or can be substantially longer so that the sheet 20 resembles a continuous web. The thickness T is generally in the range of about fifteen to about three hundred microns, of about two hundred to about three hundred microns, of about forty to about one hundred microns, and/or about fifteen to about twenty-five microns. The thickness T can be constant across the sheet's length and/or width.

The array-arrangement of the vias 22 can be in aligned rows/columns, staggered rows/columns, and/or changing rows/columns. Additionally or alternatively, the spacing between the vias 22 can be the same, can change proportionally, and/or can simply be different. Also, the vias 22 can be randomly arranged so that an array pattern or spacing sequence is not apparent. In any case, the minimum spacing between adjacent vias 22 (center-to-center) can be in the range of about thirty to seventy microns, about forty to sixty microns, and/or about fifty microns.

Referring now to FIG. 2A, the geometry of one of the vias 22 is schematically shown. The illustrated via 22 has a frustoconical shape having a z-axial dimension A equal to the thickness T of the sheet 20, a first (top) circular axial end and second (bottom) circular axial end. The area of the top end is greater than the area of the bottom end so that the via 22 tapers downwardly. (It may be appreciated, however, that the sheet 22 could simply be turned over to provide a via that tapers upwardly.)

The tapering shape of the via 22 is preferred as the geometry accommodates certain methods for making the sheet 20 as an appropriate “release angle” is necessary. In certain situations, a small release angle in the range of about 3° to about 5° might be desired so that cross-sectional areas along the axis of the via do not differ significantly. In other situations, however, large taper angles, in the range of about 30° to 60° might be more appropriate.

The tapering shape of the via 22 is preferred as the geometry accommodates certain methods and/or apparatus for making the sheet 20. In other words, one axial end will define the maximum cross-sectional area of the via 22 and the other axial end will define the minimum cross-sectional area of the via 22. In many cases, the dominating dimension (e.g., the diameter of a circular end, the length of a rectangular end, the height/base of a triangular end, etc.) defining the maximum cross-sectional axial end will be less than the thickness T of the sheet 20 and thus less than the axial dimension of the via 22. Such a dominating dimension in the range of about 0.10 microns to about 3.0 microns is contemplated by the present invention.

Additionally or alternatively, the dominating dimension of the larger axial end will be in the range of about five to twenty microns and/or about ten to about fifteen microns. If the dominating dimension of the larger axial end is in the range of five to twenty microns, the dominating dimension of the smaller axial end can be in the range of about two to about ten microns and/or about three to about five microns. For example, in the frustoconical shape shown in FIGS. 1-2, the top axial end could have a diameter of about thirteen microns and/or the bottom axial end could have a diameter of about three microns.

Other via geometries are certainly possible with and contemplated by the present invention. For example, as shown in FIGS. 2B-2J, the axial ends instead can be triangular (FIG. 2B), square (FIG. 2C), rectangular (FIG. 2D), oval (FIG. 2E), or an irregular polygon (FIG. 2K) or any other irregular shape (FIG. 2L). The walls connecting the axial ends can have a constant slope (FIGS. 2A-2E, 2K, 2L), can have a continuous changing slope (FIG. 2H), or can have a discontinuous changing slope (FIG. 2G). The geometry of the cross-sectional shape can remain the same (FIGS. 2A-2H and 2J) or can change at a predetermined depth in the via (FIG. 2I). Also, the centers of the axial ends can be aligned (FIGS. 2A-2L) or can be offset relative to one another to provide a “non-symmetrical” via (FIG. 2M). It should be noted, however, that regardless of the via geometry, an appropriate angle of release may be required across any continuous “vertical” wall segment.

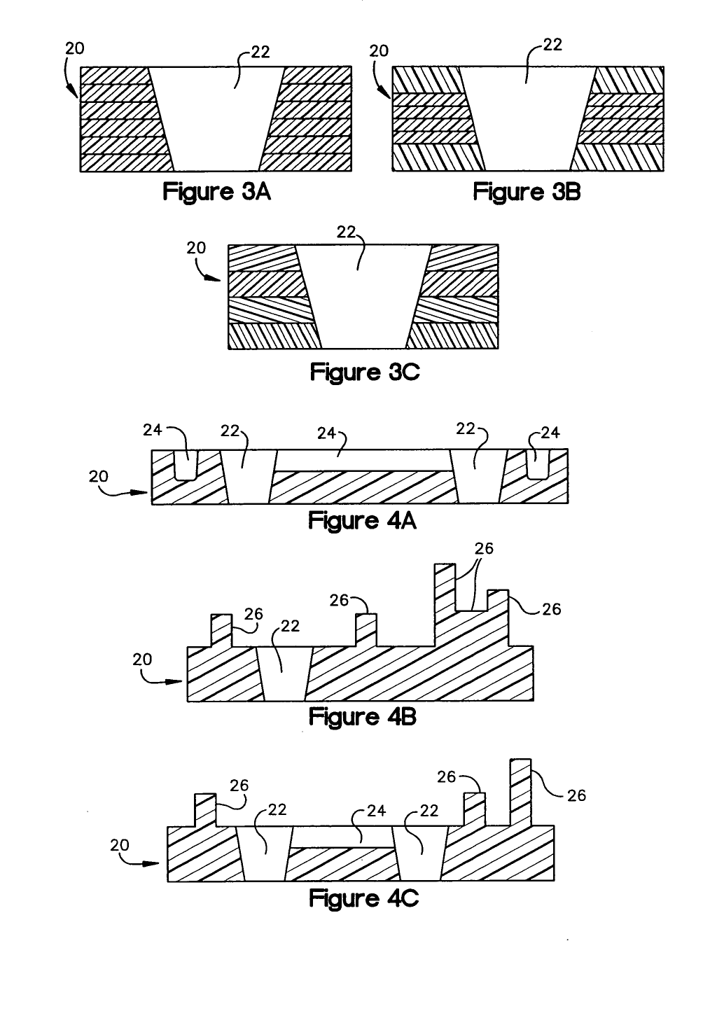

As was indicated above, the sheet 20 can be a single thermoplastic layer or a plurality of thermoplastic layers. If the sheet 20 is multi-layered as shown in FIGS. 3A-3C, it can comprise co-extruded and/or laminated layers of the same thermoplastic material (FIGS. 3A and 3B). Additionally or alternatively, the sheet 20 can comprise co-extruded and/or laminated layers of different thermoplastic materials (FIGS. 3B and 3C). The layers may be of the same or different thicknesses.

With particular reference to multi-layer sheets made of different materials, co-extruded films can be used to provide a gradient of surface properties along the z-axis of the via(s). By way of an example, a hydrophilic upper layer of a co-extruded film might hold a fluid sample while a lower layer having a more hydrophobic property might prevent flow out of the via(s). By way of another example, a gradient of hydrophilic layers could be provided that might promote or alter the energy required for flow through the via(s) due to the gradient of surface hydrophilicity differences. By way of a further example, different layers could have different resistances to etching.

The vias 22 can be the only formed working feature on the sheet 20 or can be part of an architectural scheme including other elements, as shown in FIGS. 4A-4C. For example, the microsized architecture can include other indentations 24 not extending through the thickness of the sheet 20, such as recesses, wells, and/or channels (FIGS. 4A and 4C). Additionally or alternatively, projecting structures 26 of the same or different heights can be provided (FIGS. 4B and 4C). If the microsized architecture includes only indentations (FIG. 2 and FIG. 4A), the sheet 20 can have flat upper and lower x-y surfaces. If the microsized architecture includes projecting structures 26 (FIGS. 4B and 4C), the sheet 20 will have a multi-height topology.

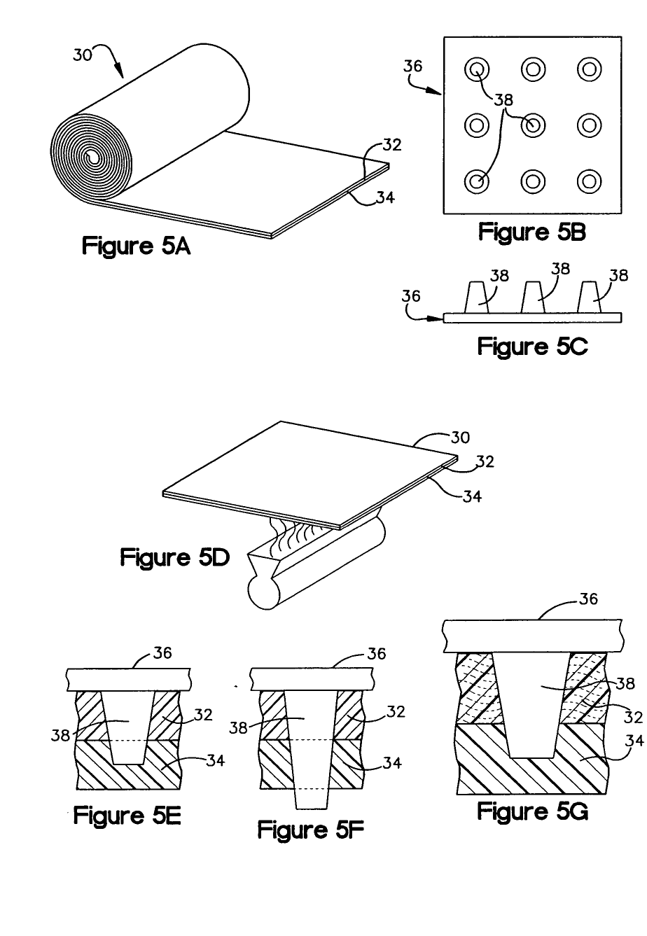

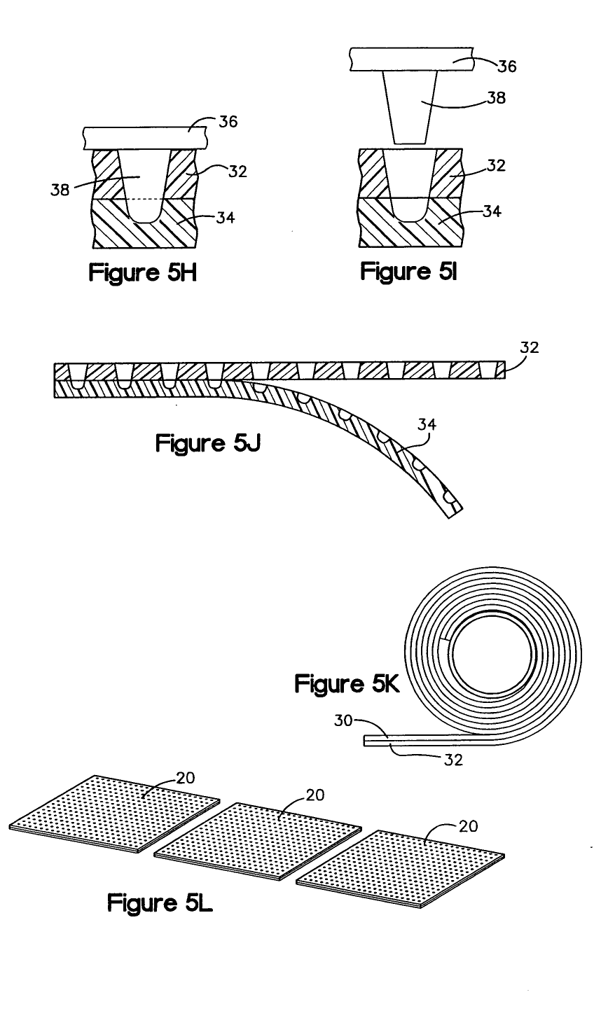

Referring now to FIGS. 5A-5I, the steps of a method for making the embossed sheet 20 are schematically shown. In this method, a web 30 is provided, having at least a thermoplastic layer 32, and the web 30 can also include a plastic carrier layer 34 (FIG. 5A). As was explained above, the thermoplastic layer 32 can comprise a polymer or copolymer having properties compatible with the assembly steps and with the eventual intended use of the sheet 22.

The carrier layer 34 can provide several functions. First, it can serve to maintain the thermoplastic layer 32 under pressure against a belt while traveling around heating and cooling stations and/or while traversing the distance between them, thus assuring conformity of the thermoplastic layer 32 with the precision pattern of the tool 56 during the change in temperature gradient as the web (now embossed sheet) drops below the glass transition temperature of the material. Second, the film can act as a carrier for the web in its weak “molten” state and prevents the web from adhering to the pressure rollers 58 as the web is heated above the glass transition temperature. Thirdly, the carrier layer can receive an impression, or at least act as an “anvil,” during the process of embossing through holes in the thermoplastic layer 32 and thereby facilitate the embossing of through holes in accordance with the present invention.

Accordingly, the plastic carrier layer 34 can be selected based upon its having a glass transition temperature substantially greater than the glass transition temperature of the thermoplastic layer 32. Additionally or alternatively, the carrier layer 34 can be chosen to provide the adjacent surface of the layer 32 with a flat and highly finished profile suitable for other processing. The ability of the carrier layer 34 to support the thermoplastic layer 32 during certain method steps can also be taken into consideration when picking a carrier material. Possible material candidates for the carrier layer 34 include, but are not limited to, polyester, such as a Mylar film. That being said, any carrier material, thermoplastic, thermosetting or otherwise, compatible with the manufacturing method, is contemplated by the present invention.

A tool 36 is provided, having a series of projections 38 sized, shaped and arranged to correspond to the desired array of vias 22 on the sheet 22. (FIGS. 5B and 5C). Thus, to make the sheet 20 illustrated in FIGS. 1 and 2, the projections 38 would have a frustoconical shape and would be arranged in aligned rows/columns. It may be noted, however, that the distal end portions of the projections might need to represent an extension of the smaller axial end of the via 22, as it may extend past the distance defined bottom surface of the sheet 22.

The tool 36 can be made of a suitable material, such as nickel, which will withstand the subsequent method steps. For example, the method includes steps which can involve heating and cooling of the tool 36. Accordingly, the dimensions of the tool 36 may affect the heating/cooling energy necessary to reach the required temperature gradients. A thin tool (about 0.010 inches [0.254 mm] to about 0.030 inches [0.768 mm]) will facilitate rapid heating and cooling while a thicker tool will retain heat.

The tool 36 can be manufactured by known techniques to create micropatterns in rigid substrates such as ruling, diamond turning, photolithography, deep reaction ion etching, plasma etching, reactive ion etching, deep x-ray lithography, electron beam lithography, ion milling or combinations thereof. For example, a female master can be electroformed and used to create several male patterns that are assembled together to form the tool 36. Further details of making the tool 36 can be found in U.S. Pat. Nos. 4,478,769 and 5,156,863. (These patents are now assigned to the assignee of the present invention and their entire disclosures are hereby incorporated by reference.)

In the method of the present invention, the thermoplastic layer 32 is heated until it is sufficiently flowable. (FIG. 5D.) In many cases, this will require that the layer 32 is heated to at least the glass transition temperature T_{g}—that is, the temperature at which the material changes from the glassy state to the rubbery state. The term “glass transition temperature” is a well known term of art and is applied to thermoplastic materials as well as glass. It is the temperature at which the material begins to flow when heated. For various extendable types of acrylic, the glass transition temperatures begin at about 200° F. and, for polyester (Mylar), it begins at about 480° F. to 490° F.

Glass transition temperatures in the range of about 325° F. to about 410° F. (about 160° C. to about 215° C.) are typical for materials used to make the thermoplastic layer 32. In some cases, the temperature will have to be increased to a flow temperature Tₑ in excess of the glass transition temperature T_{g} for the material to go from the rubbery state to a flowable state. For example, Polysulfone has a beginning glass transition temperature T_{g} of about 190° C., changing into a rubbery state at about 210° C. and beginning to flow at about 230° C.

Accordingly, two temperature reference points are significant in the present invention: T_{g} and Tₑ. T_{g} is defined as the glass transition temperature, at which plastic material will change from the glassy state to the rubbery state. It may comprise a range before the material may actually flow. Tₑ is defined as the embossing or flow temperature where the material flows enough to be permanently deformed by the embossing process, and will, upon cooling, retain form and shape that matches, or has a controlled variation (e.g. with shrinkage) of, the embossed shape. Because Tₑ will vary from material to material, and also will depend on the thickness of the film material and the nature of the dynamics of the embossing apparatus, the exact Tₑ temperature is related to conditions including the embossing pressure(s), the temperature input of apparatus and the speed of apparatus, as well as the extent of both the heating and cooling sections in the reaction zone.

The embossing temperature Tₑ must be high enough to exceed the glass transition temperature T_{g}, so that adequate flow of the material can be achieved to provide highly accurate embossing of the film by the apparatus. Numerous thermoplastic materials may be considered as polymeric materials to provide the layer 32. (However, not all can be embossed on a continuous basis.) These materials include thermoplastics of a relatively low glass transition temperature (up to 302° F./150° C.), as well as materials of a higher glass transition temperature (above 302° F./150° C.). Typical lower glass transition temperatures (i.e. up to 302° F./150° C.) include materials used, for example, to emboss cube corner sheeting, such as vinyl, polymethyl methylacrylate, low T_{g} polycarbonate, polyurethane, and acrylonitrile butadiene styrene (ABS). The glass transition T_{g} temperatures for such materials are 158° F., 212° F., 302° F., and 140° to 212° F. (272° C., 100° C., 150° C., and 60° to 100° C.). Higher glass transition temperature thermoplastic materials (i.e. with glass transition temperatures above 302° F./150° C.) which applicants' assignee has found suitable for embossing precision microvias, are disclosed in U.S. patent application Ser. No. 09/596,240 filed on Jun. 16, 2000, U.S. patent application Ser. No. 09/781,756 filed on Feb. 12, 2001, and/or U.S. patent application Ser. No. 10/015,319 filed on Dec. 12, 2001. These polymers include polysulfone, polyarylate, cyclo-olefinic copolymer, high T_{g} polycarbonate, and polyether imide. These earlier applications are owned by the assignee of the present invention and their entire disclosures are hereby incorporated by reference.

A table of exemplary thermoplastic materials, and their glass transition temperatures, appears below as Table I:

TABLE I

| Symbol | Polymer Chemical Name | Tg ° C. | Tg ° F. |
|---|---|---|---|
| PVC | Polyvinyl Chloride | 70 | 158 |
| Phenoxy | Phenoxy PKHH | 95 | 203 |
| PMMA | Polymethyl methacrylate | 100 | 212 |
| BPA-PC | Bisphenol-A Polycarbonate | 150 | 302 |
| COC | Cyclo-olefinic copolymer | 163 | 325 |
| Polysulfone | Polysulfone | 190 | 374 |
| Polyacrylate | Polyacrylate | 210 | 410 |
| PC | High T_{g} polycarbonate | 260 | 500 |
| PEIPI | Polyether imide | 260 | 500 |
| Polyurethane | Polyurethane | varies | varies |
| ABS | Acrylonitrile Butadiene Styrene | 60-100 | 140-212 |

The thermoplastic material also may comprise a filled polymeric material, or composite, such as a microfiber filled polymer, and may comprise a multilayer material, such as a coextrudate of PMMA and BPA-PC.

The tool 36 and the thermoplastic layer 32 are brought into contact with each other so that, when thermoplastic material is sufficiently flowable, the projections 38 extend through the thermoplastic layer 32 to the carrier layer 34. (FIGS. 5E and 5F.) The resinous material of the layer 32 is sufficiently flowable to mold around the projections 38. (FIG. 5G.) Thus, the projections 38 do not puncture or pierce the thermoplastic layer 32 as occurs when a nail is hammered through a block of wood. Instead, the interaction between the thermoplastic layer 32 and the projections 38 more accurately duplicates what would occur if this nail was dipped in a bucket of water. Applicants have observed as a rule of thumb that for good fluidity of the molten thermoplastic material, the embossing temperature Tₑ should be at least 50° F. (10° F. C), and more advantageously between 100° F. to 150° F. (38° C. to 66° C.), above the glass transition temperature of the thermoplastic layer 32.

The distal end portions of the projections 38 can extend partially into the carrier layer 34 (FIG. 5E) or can extend entirely therethrough (FIG. 5F). It is noted that since the size and shape of the via 20 can change depending upon the penetration of the projection 38, some type of depth registration may be required. This registration can be accomplished by measuring the vertical position of the tool 36 (FIGS. 5E and 5F) and/or by sensing the penetration of the projections 38 through the carrier layer 34 (FIG. 5F). It may be noted that the carrier layer 34 acts as anvil, in effect, as the via 22 is embossed through the thermoplastic layer 32. While it is desirable to control the form of the via, the carrier layer does not have to be cleanly embossed, since this is not part of the final product. Accordingly, the carrier layer 32 can be “punched” while it is below its glass transition temperature.

With the projections 38 still extending to or through the carrier layer 34, the web 30 is cooled so that the thermoplastic material solidifies around the projections. (FIG. 5H.) After sufficient solidification, the material surrounding the projections 38 will no longer depend upon the tool 10 for shape-defining purposes. The tool 36 is then stripped from the web 30, leaving behind the vias 22. (FIG. 5I.)

The forming steps of the present invention are believed to provide essentially exact-sized surfaces and very precise inter-via patterns. The molded via-defining surfaces are formed without distortion, thereby allowing the enhanced smoothness of flat and curved regions of the via geometry. Also, with via shapes incorporating polygonal geometries (see e.g., FIGS. 2B-2D, 2G and/or 2I), the via-defining surfaces have increased angular accuracy, and sharp corners can be incisively obtained.

The via-defining surfaces of the present invention are believed to be structurally superior (and in any event structurally different) than vias formed by conventional methods, such as curing, injection molding, ablation, stamping, and punching techniques. In a curing process, for example, the molded material must undergo a significant chemical change, thereby making final geometries (dimensions and surface profiles) difficult to predict in a micro-tolerance situation, especially via-to-via. Also, since a curing process by definition changes the chemistry of the starting polymer, the properties of the post-cure structure can differ from those of the pre-cure structure. Accordingly, while testing local properties of the starting polymer may help estimate the characteristics of the cured material, these characteristics usually must be re-tested in the final product. Moreover, even the same starting polymer can yield different final-product properties (depending upon the exact nature of the curing process), whereby testing of each batch of products is often necessary.

In an injection molding process, pressure is required to push the material into the appropriate cavities. This almost always results in some degree of orientation twist and/or relaxation stress. Also, certain parts of the mold often tend to cool faster than other parts of the mold, whereby uniform films are difficult to achieve.

An ablation process (such as laser ablation) involves the vaporization of a via-shaped piece of material, a stamping process requires the compaction of a via-shaped piece of material into surrounding regions, and a punching process requires the removal of a via-shaped piece of material. To the extent that sizing-specification and/or pattern-precision could be obtained with an ablation, stamping, and/or punching process, the profile of the surfaces would be difficult, if not impossible, to maintain, and the thrust of the tooling would have to be very precisely controlled.

Accordingly, the present invention is believed to provide via-defining surfaces which have closer size-exactness, enhanced pattern precision, increased angle accuracy, and/or greater surface texture control than via-defining surfaces formed by prior art methods. Additionally, residual stresses are avoided with the present invention, thereby providing essentially stress-free microstructures. Moreover, the local properties of the sheet material will not change during the via-forming process (since there is no change in chemistry), whereby post-forming testing of these properties is not necessary.

Once the web 30 and the tool 36 have been stripped from each other, the carrier layer 34 can be removed (e.g., peeled) from the thermoplastic layer 32 (FIG. 5J). If the web 30 reflected the desired size of the sheet 20, then the production of the sheet 20 is complete and it is ready for further processing, assembly, and/or finishing. If the web 30 was of a continuous length, the product can be wound onto a roll (FIG. 5K) for later sectioning into desired lengths. Alternatively, the web 30 can be cut into sections of the desired sheet dimensions (FIG. 5L). It should be noted that the peeling step can be performed before, during or after the winding and/or cutting steps.

The method of the present invention can be performed with the machines and apparatus disclosed in U.S. patent application Ser. No. 09/596,240 filed on Jun. 16, 2000, U.S. patent application Ser. No. 09/781,756 filed on Feb. 12, 2001, and/or U.S. patent application Ser. No. 10/015,319 filed on Dec. 12, 2001. These applications are owned by the assignee of the present invention and their entire disclosures are hereby incorporated by reference.

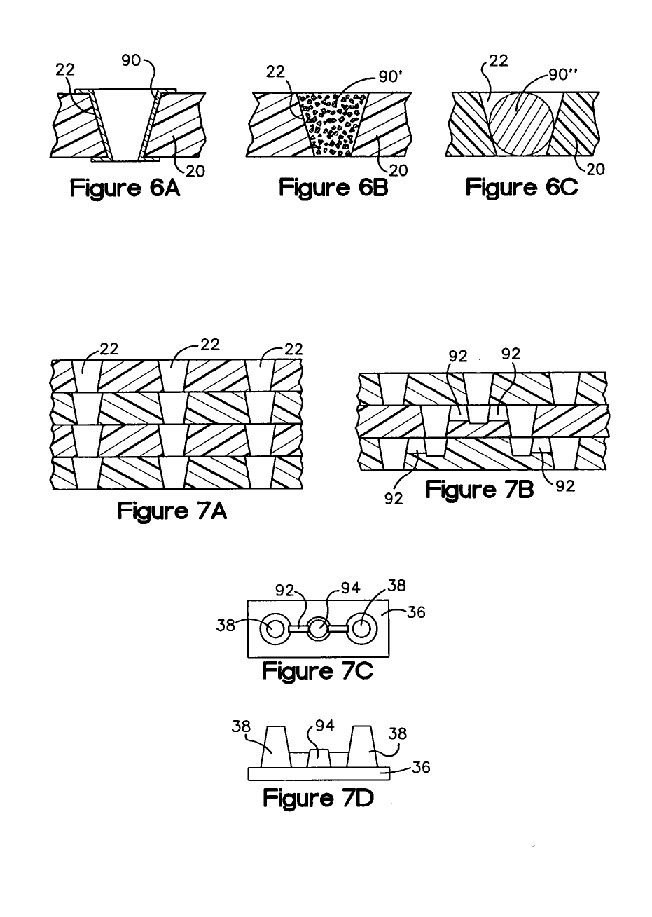

As was indicated above, the sheet 20 can be incorporated into a variety of applications, each of which may require further processing and/or assembly. By way of example, in electrical circuitry constructions, the via-defining surfaces can be coated with an electrical conductive coating 90 (FIG. 6A), electrically conductive particles 90′ can be placed in the via 22 (FIG. 6B), and/or an electrically conductive object 90″ (e.g. a sphere having a diameter less than that of the circular top end and greater than that of the circular bottom end of a frustoconical shaped via) can be dropped into the via 22 (FIG. 6C). Further details of possible conductive vias are set forth in co-pending U.S. application Ser. No. 60/349,907 filed concurrently with the present application. This application is assigned to the assignee of the present invention and its entire disclosure is hereby incorporated by reference.

A plurality of sheets 20 can be stacked to provide a three-dimensional network of passageways with the vias 22 providing inter-level communication (FIG. 7A). Multi-level sheet assemblies might be especially helpful in fluid applications where the sheet 20 contains other microsized architecture, forming passageways 92 to and from the vias 22 (FIG. 7B). The passageways 92 can be formed simultaneously with the vias 22 by modifying the tool 36 to include “shorter” projections 94 which do not extend through the thermoplastic layer 32. (FIGS. 7C-7E). Also, in filtering situations, vias 22 between stacked sheets 20 could be used to distribute and equalize flow downstream of the filter entrance.

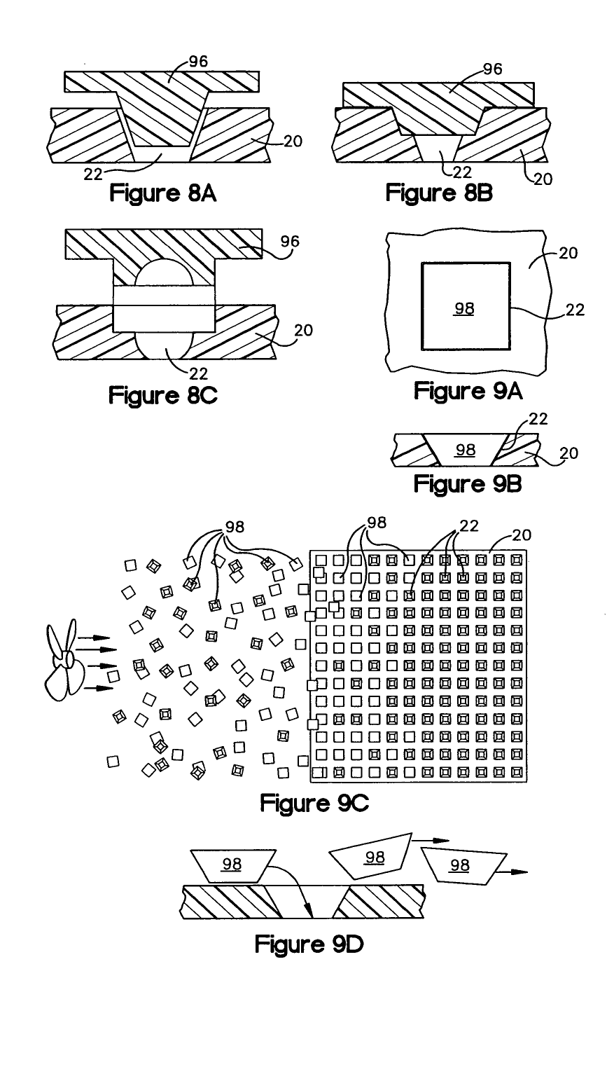

A lid or cover 96 can be provided for the sheet 22 which results in the top of each or some of the vias 22 being covered (FIGS. 8A-8C). Details of possible lidded and/or covered constructions are set forth in co-pending U.S. application Ser. No. 60/349,909, filed on Jan. 18, 2002. This application is assigned to the assignee of the present invention and its entire disclosure is hereby incorporated by reference.

The vias 22 can define recesses which receive complementary shaped microstructure blocks 98 (FIGS. 9A and 9B). For efficient assembly, a multitude of the blocks 98 (e.g., chips) can be provided in a slurry that is passed over the sheet 22 by, for example, a soft air stream (FIG. 9C). Properly positioned blocks 98 will drop into the vias 22 with the remainder being swept downstream (FIG. 9D).

These and other further processing and assembly steps can be performed to create a product suitable for incorporation into a filtering, sampling, electrical or other application. Also, such processing and assembly steps can be combined as appropriate. For example, sheets 20 containing the electrically conductive vias 22 shown in FIGS. 6A-6C can be stacked as shown in FIG. 7A and/or provided with a lid 96 as shown in FIG. 8A-8C. Additionally or alternatively, sheets 20 containing the microstructure blocks 98 shown in FIG. 9A can be likewise stacked and/or covered.

Although the invention has been shown and described with respect to certain preferred embodiments, it is obvious that equivalent and obvious alterations and modifications will occur to others skilled in the art upon the reading and understanding of this specification. The present invention includes all such alterations and modifications and is limited only by the scope of the following claims.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. A method of making a sheet having microsized architecture including at least one via, said method comprising the steps of:
providing a thermoplastic layer;
providing a tool having a projection that is sized, shaped, and arranged to correspond to each via in the microsized architecture;
heating the thermoplastic layer so that the thermoplastic material is sufficiently flowable;
positioning the tool and the thermoplastic layer relative to each other so that the projections extend through the sufficiently flowable thermoplastic material;
cooling the thermoplastic layer so that the thermoplastic material solidifies around the projection(s); and
stripping the tool from the thermoplastic layer after sufficient solidification of the thermoplastic material.

47. A method as set forth in claim 46, wherein said heating step comprises heating the thermoplastic layer to at least the glass transition temperature of the thermoplastic material.

48. A method as set forth in claim 47, wherein said heating step comprises heating the thermoplastic layer in excess of the glass transition temperature of the thermoplastic material.

49. A method as set forth in claim 46, wherein the heating step comprises heating the thermoplastic layer in a range of about 325° F. to about 410° F. (about 160° C. to about 215° C.).

50. A method as set forth in claim 46, wherein depth registration is performed during said positioning step to assure appropriate positioning of the projection(s).

51. A method as set forth in claim 46, further comprising the step of winding the embossed thermoplastic layer onto a roll.

52. A method as set forth in claim 46, further comprising the step of sectioning the thermoplastic layer into desired lengths after said stripping step.

53. A method as set forth in claim 46, wherein said providing step comprises providing a web having at least the thermoplastic layer and a plastic carrier layer.

54. A method as set forth in claim 53, wherein said positioning step results in the projection(s) extending at least partially through the carrier layer.

55. A method as set forth in claim 54, wherein said positioning step results in the projection(s) extending completely through the carrier layer.

56. A method as set forth in claim 54, further comprising the step of removing the carrier layer from the thermoplastic layer.

57. A method as set forth in claim 56, wherein said removing step is performed before, during, or after winding and/or cutting steps.
